(19) United States
(12) Patent Application Publication
(10) Pub. No.: US 2022/0395811 A1
(43) Pub. Date: Dec. 15, 2022

(54) CATALYST COMPOSITION AND METHOD OF MAKING THEREOF FOR CARBON MONOXIDE PRODUCTION

(71) Applicant: UNIVERSITI KEBANGSAAN MALAYSIA, Selangor (MY)

(72) Inventors: Mohd. Ambar YARMO, Selangor (MY); Wan Nor Roslam WAN ISAHAK, Selangor (MY); Mohamed Wahab MOHAMED HISAM, Selangor (MY); Mohammad KASSIM, Selangor (MY); Muhammad Rahimi YUSOP, Selangor (MY); Masli Irwan ROSLI, Selangor (MY); Maratun Najiha TAHARI, Selangor (MY); Siti Sarahah SULHADI, Selangor (MY)

(21) Appl. No.: 17/762,353

(22) PCT Filed: Sep. 18, 2020
(86) PCT No.: PCT/MY2020/050089

§ 371 Date: Mar. 21, 2022

(30) Foreign Application Priority Data
Sep. 20, 2019 (MY) PI2019005506

(51) Int. Cl. B01J 23/02; B01J 21/10; B01J 21/18; B01J 6/00; B01J 37/02; B01J 37/08; C01B 32/40; B01J 8/24

(52) U.S. Cl. CPC B01J 23/02; B01J 21/10; B01J 21/18; B01J 6/001; B01J 37/0201; B01J 37/08; C01B 32/40; B01J 8/24

(57) ABSTRACT

The present invention provides an impregnated catalyst composition for production of carbon monoxide comprising: 30 wt %-50 wt % metal oxide and 50 wt %-70 wt % support material. Another aspect of the present invention is to provide a method of preparation of an impregnated catalyst for carbon monoxide production (10) and a method for producing carbon monoxide (20) according to the impregnated catalyst of the present invention. The present invention is able to reduce the reaction temperature by 1 fold and also able to reduce the usage of energy but maintain its good production quality. Besides, selectivity of the present invention is high, hence able to produce high purity of carbon monoxide.

### FIELD OF INVENTION

The present invention relates to a catalyst composition. More particularly, the present invention relates to a catalyst composition and method of making thereof for carbon monoxide production.

### BACKGROUND OF THE INVENTION

Carbon dioxide is probably the most infamous gases among all the greenhouse gases. CO₂ enters the atmosphere through burning fossil fuels (coal, natural gas, and oil), solid waste, tress and wood product and also as a result of certain chemical reaction. It is relatively less harmful to human health but it has proven to contribute to other aspects such as the extreme weather and global warming that we are facing right now (Michael 2017). Therefore, the gas required less formation energy had contributed to its stability and increasing its concentration in our current atmosphere. Due to the industrial revolution, consumption of fossil fuels through energy-driven has led to a rapid increase in CO₂ emission. This will lead to a planetary warming impact through disrupting the global carbon cycle. The CO₂ emission has a significant impact on the concentration of CO₂ in the earth's atmosphere. For over the past 2000 years, it is shown that the concentration of CO₂ was 270-285 part per million (ppm) until the 18^{th} century (Hannah& Max 2018). Therefore, to stabilize or to reduce the atmospheric CO₂ concentration, the emission not only to be stabilized but also need to be decreased significantly.

Concentration of CO₂ in atmosphere can be reduced about 40%, by converting CO₂ to CO which is can be used as industry feed stocks for producing synthetic fuels (Feng, 2014). There are several researchers who had studied these CO₂ splitting catalysts. They have discovered a number of catalysts that enable first stage of split CO₂ when the gas is bubbled up through water in the presence of an electric current. However, the catalyst splits more water than it does CO₂, making molecular hydrogen (H₂) and a less energy-rich compound (Robert, 2017). The electrochemical reduction of carbon dioxide to CO is usually described as: CO₂+2H⁺+2e⁻→CO+H₂O (Aaron et al, 2012). Though, they found that further studied should focusing on the development innovative composite and nanostructured catalyst materials to overcome the challenges of insufficient catalytic activity, product selectivity, and catalytic stability, the technology of CO₂ electroreduction will become practical in the near future (Jinli et al, 2014). Overall, this system has some disadvantages and challenges such as: slow kinetics of CO₂ electroreduction, even when electrocatalysts and high electrode reduction potential are applied, low energy efficiency of the process due to the parasitic or decomposition reaction of the solvent at high reduction potential and 3) high energy consumption.

There are also other prior arts which disclosed the involvement of catalyst for carbon monoxide production and U.S. Pat. No. 5,830,425, GB 2053947A, US 20070259976 and US 20100160464A1 are to be mentioned. In details, U.S. Pat. No. 5,830,425 disclosed iron catalyst impregnated with a solution of salts, GB 2053947A disclosed a catalyst impregnated with several solutions, US 20070259976 disclosed wet impregnated of rhutenium in crystalline alumina-silicate, US 20100160464A1 disclosed zeolite extrudate impregnated with cobalt salt. Although the presence of the catalyst manages to reduce the energy involved in the reaction, it is best to find other alternative that able to reduce the energy significantly lower and at the same time maintain the quality and effectiveness of the produced carbon monoxide so that lots of energy, cost and time could be saved efficiently. Besides, it is also important to find a catalyst which is able to selectively promotes the production of carbon monoxide without poisoning the end product or will choked during the reaction.

Therefore, improvement of catalysts is still in need in order to demonstrate much better method for production of carbon monoxide with better quality and effectiveness.

### SUMMARY OF THE INVENTION

An aspect of the present invention is to provide an impregnated catalyst composition for production of carbon monoxide comprising: 30 wt %-50 wt % metal oxide; and 50 wt %-70 wt % support material.

Accordingly, the metal oxide of the present invention selected from calcium oxide, magnesium oxide and combination thereof, ferum oxide and lanthanum oxide.

Accordingly, the source of the metal oxide is selected from calcined dolomite, calcined carbonate, calcined nitrate, and calcined hydroxide.

Accordingly, the support material is selected from activated carbon.

Accordingly, the impregnated catalyst yields carbon monoxide ranging from 33.0%-65.5%.

Accordingly, the impregnated catalyst has high performance stability ranging from 4 hours to 20 hours.

Another aspect of the present invention is to provide a method of preparation of an impregnated catalyst for carbon monoxide production comprising steps of: (i) providing a precursor and support material; (ii) adding the precursor into water to form a solution and adding the solution with a corresponding metal cation into the support material to form a mixture; (iii) stirring the mixture to form an impregnated catalyst; and (iv) drying and calcining the impregnated catalyst.

Accordingly, the precursor in step (i) is selected from nitrate salt or hydroxide.

Accordingly, the support material in step (i) is selected from activated carbon.

Accordingly, the stirring step in step (iii) is conducted for 3-5 hours at 40° C.-80° C.

Accordingly, the drying step in step (iv) is conducted at a temperature of 110° C.-150° C. for overnight.

Accordingly, the calcining step in step (iv) is conducted at a temperature of 400° C.-850° C.

Accordingly, the impregnated catalyst is prepared with a ratio of 30 wt %-50 wt % precursor; and 50 wt %-70 wt % support material.

Accordingly, the produced impregnated catalyst yields carbon monoxide ranging from 33 .0%-65.5%.

Accordingly, the produced impregnated catalyst has high performance stability ranging from 4 hours to 20 hours.

Yet, another aspect of the present invention is to provide a method for producing carbon monoxide comprising the steps of; (i) loading an impregnated catalyst according to Claim 1 to Claim 5 into a reactor; (ii) heating the impregnated catalyst with flowing nitrogen gas at a selected flow rate until reach selected temperature; (iii) reacting the heated impregnated catalyst with flowing carbon dioxide gas at a selected flow rate to produce carbon monoxide; and (iv) regain the impregnated catalyst for reuse; wherein the steps occur simultaneously within the reactor, thereby the selectively carbon monoxide is collected at a temperature range of 700° C.-850° C.

Accordingly, the reactor is selected from a fluidized bed reactor or fixed bed reactor.

Accordingly, the selected flow rate of nitrogen and carbon monoxide gas is ranging from 50-100 mL/min and 16%-99.9% respectively.

Accordingly, the use of the catalyst for carbon monoxide production wherein reaction temperature is reduced by 1 fold.

Accordingly, the use of the catalyst for carbon monoxide production wherein the reaction temperature ranges from 700° C.-850° C.

Advantageously, the catalyst of the present invention is able to reduce the reaction temperature by 1 fold with reaction temperature ranges from 700° C.-850° C.

Advantageously, the present invention is able to reduce the usage of energy but maintain its good production quality.

Advantageously, selectivity of the present invention is high, hence able to produce high purity of carbon monoxide.

### BRIEF DESCRIPTION OF THE DRAWINGS OF THE PRESENT INVENTION

The examples are presented only to illustrate the preferred embodiments of the present invention and not intended in any way to limit the scope of the present invention.

FIG. 1 illustrates the method of preparation of an impregnated catalyst for carbon monoxide production;

FIG. 2 illustrates the method of carbon monoxide production;

FIG. 3 illustrates reaction performance over X3 catalyst;

FIG. 4 illustrates CO₂ conversion over X3 with physically mix method;

FIG. 5 illustrates X3 catalyst performance at reaction temperature of 850° C., amount of catalyst of 10 g at 100 mL/min of CO₂ gas flowrate;

FIG. 6 illustrates X3 catalyst performance at reaction temperature of 850° C., amount of catalyst of 10 g at 50 mL/min of CO₂ gas flowrate;

FIG. 7 illustrates X3 catalyst performance at reaction temperature of 750° C., amount of catalyst of 10 g at 50 mL/min of CO₂ gas flowrate;

FIG. 8 illustrates CO yield over D3 catalyst at 850° C. and 50 mL/min;

FIG. 9 illustrates CO yield over D4 catalyst at 850° C. and 50 mL/min; and

FIG. 10 illustrates CO yield over D5 catalyst at 850° C. and 50 mL/min.

### DETAILED DESCRIPTION OF THE INVENTION

An aspect of the present invention is to provide an impregnated catalyst composition for production of carbon monoxide comprising: 30 wt %-50 % wt metal oxide and 50 wt %-70 wt % support material.

Accordingly, metal oxide is selected from calcium oxide, magnesium oxide and combination thereof, ferum oxide and lanthanum oxide.

Accordingly, the source of metal oxide is possibly selected from calcined dolomite, calcined carbonate, calcined nitrate and calcined hydroxide. For further explanation, the metal oxide from calcined dolomite could be retrieved via calcination process. In details, the combination of calcium carbonate and magnesium carbonate will form a metal carbonate which is known as dolomite. The metal carbonate is then formed into the metal oxide after calcination process at 850° C.

Accordingly, the support material is selected from activated carbon or carbonaceous materials such as charcoal, coal and petroleum coke. In details, the activated carbon play role as a support material and at the same time as a carbon source for CO₂ conversion reaction into CO.

In one embodiment of the present invention, the impregnated catalyst according to the present invention manage to yield carbon monoxide ranging from 33.0%-65.5%. In details, the impregnated catalyst containing 50% dolomite and activated carbon yields 57.2% carbon monoxide, the impregnated catalyst containing 40% dolomite and activated carbon yields 63.7% carbon monoxide, the impregnated catalyst containing 30% dolomite and activated carbon yields 62.2% carbon monoxide, the impregnated catalyst containing 30% calcium oxide and activated carbon yields 65.5% carbon monoxide and 53.0% via physical mix. For the impregnated catalyst containing lanthanum oxide and activated carbon yields 52.0% carbon monoxide, impregnated catalyst containing iron oxide and activated carbon yields 58.0% carbon monoxide and impregnated catalyst containing magnesium oxide and activated carbon yields 33.0% carbon monoxide.

Accordingly, the impregnated catalyst has high performance stability ranging from 4 hours to 20 hours.

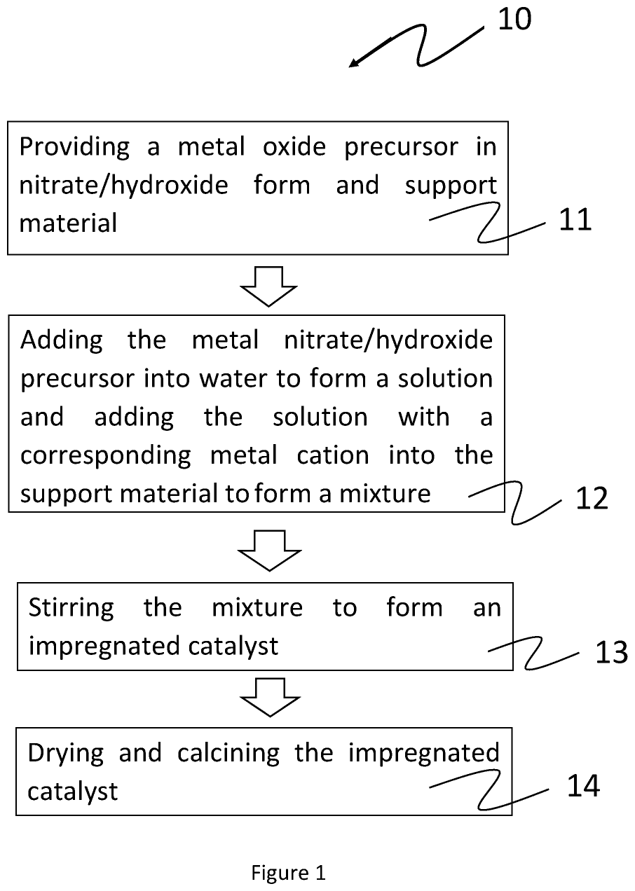

Another aspect of the present invention is related to a method (10) of preparation of an impregnated catalyst for carbon monoxide production. FIG. 1 shows in details the method of preparation of an impregnated catalyst for carbon monoxide production (10). As referring to FIG. 1, the method (10) of the present invention comprising steps of providing a precursor and support material (11).

The precursor is selected from hydroxide or nitrate salt. The support material is selected from activated carbon or carbonaceous materials such as charcoal, coal and petroleum coke.

The impregnated catalyst is prepared with a ratio of 30 wt %-50 wt % precursor and 50-70 wt % support material.

Then, the method continues with adding the precursor into water to form a solution and adding the solution with a corresponding metal cation into the support material to form a mixture (12).

After that, the mixture is stirred to form an impregnated catalyst (13) whereby stirring step is conducted for 4-5 hours at 40° C.-80° C. Finally, drying the impregnated catalyst at a temperature of 110° C.-150° C. for overnight and calcining the impregnated catalyst at a temperature of 400° C.-850° C. (14).

Accordingly, the produced impregnated catalyst yields carbon monoxide ranging from 33.0%-65.5%. In details, the impregnated catalyst containing 50% dolomite and activated carbon yields 57.2% carbon monoxide, the impregnated catalyst containing 40% dolomite and activated carbon yields 63.7% carbon monoxide, the impregnated catalyst containing 30% dolomite and activated carbon yields 62.2% carbon monoxide, the impregnated catalyst containing 30% calcium oxide and activated carbon yields 65.5% carbon monoxide and 53.0% via physical mix. For the impregnated catalyst containing lanthanum oxide and activated carbon yields 52.0% carbon monoxide, impregnated catalyst containing iron oxide and activated carbon yields 58.0% carbon monoxide and impregnated catalyst containing magnesium oxide and activated carbon yields 33.0% carbon monoxide.

Accordingly, the produced impregnated catalyst has high performance stability ranging from 4 hours to 20 hours.

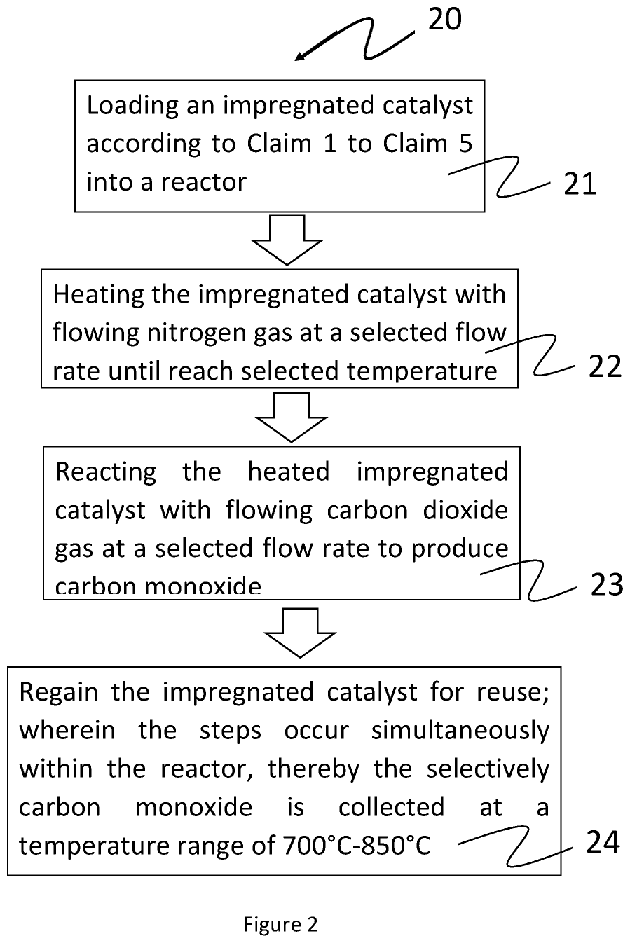

Another aspect of the present invention is to provide a method for carbon monoxide production. FIG. 2 shows in details the method for carbon monoxide production (20). As referring to FIG. 2, the method for carbon monoxide production (20) of the present invention comprising the steps of: loading an impregnated catalyst into a reactor (21). The reactor is selected from a fluidized bed reactor or fixed bed reactor.

The method is continued with heating the impregnated catalyst with flowing nitrogen gas at a flow rate selected from the range of 50-100 ml/min until reach selected temperature ranging from 700-850° C. (22). Then, the heated impregnated catalyst is reacted with flowing carbon dioxide gas at selected flow rate ranging from 50-100 ml/min to produce carbon monoxide (23). Finally, the impregnated catalyst is regained for reuse; wherein the steps occur simultaneously within the reactor, thereby the selectively carbon monoxide is collected at a temperature range of 700° C.-850° C. (24).

The catalyst for carbon monoxide production according to the present invention wherein reaction temperature is reduced by 1 fold.

The catalyst for carbon monoxide production according to the present invention wherein the reaction temperature ranges from 700° C.-850° C.

The present invention will be explained in more details through the examples below. The examples are presented only to illustrate the preferred embodiments of the present invention and not intended in any way to limit the scope of the present invention.

### EXAMPLE 1

In general, the catalyst of the present invention is selected metals mixed with charcoal to develop metal-charcoal catalyst and applied in converting CO₂ to CO. This equation (CO_{2(g)}+C₍ₛ₎ [symbol] 2CO_{(g)}) known as Boudouard reaction, CO₂ can be converted to CO in which solid carbon (C) reacts with CO₂. This system is a straightforward route for the CO₂ reduction, 100% percent selectivity and less energy consumption compared to electrochemical catalysis. The objective of developing the present invention is to provide a new catalyst formula which suitable and practicable for this process since better catalyst has not been found. The chosen metals catalyst were Fe (transition), La (rare earth metal) and Mg (alkaline earth), Ca (alkaline earth) and these catalysts were respectively synthesized with activated charcoal through impregnation method. The prepared catalyst will characterize using several techniques. The catalytic activities of the prepared catalyst will be discussed in term of CO yield production using fluidized bed reactor and gas chromatography (GC).

### Methodology

In this research, several type of catalysts were prepared using wet impregnation method using nitrate salts precursor. CO conversion was accomplished by using fluidized bed reactor with first step was to load 10 g of prepared catalysts sample into 2 cm quartz tube. The sample was heated at rate 20° C./min until reached final temperature of 850° C. with flowing of 99.9% nitrogen (N₂) gas, then followed by 99.9% carbon dioxide with flow rate of 250 ml/min to study catalytic CO₂ conversion. The resulting gaseous products were collected at 1 hour interval and analysed by gas chromatography.

### Results and Discussion

In this work, several catalysts based on activated carbon play role as a support material and at the same time as a carbon source to proceed the CO₂ conversion reaction into CO. The catalysts with different element and active metal content such as 30% CaO, 30% dolomite and 50% dolomite on activated carbon denoted as X3, D3 and D5, respectively. All the catalysts were synthesized using wet-impregnation method to produce chemically interaction between calayst and support. A X3 catalyst sample prepared using simple physical mixing was then compared with the other catalysts to evaluate catalyst and support interaction on CO yield and selectivity. Improvement on the interaction among metal oxide and support carbon change the themodynamic properties of the catalyst and successfully improve the reaction with more CO yield was obtained. There are several parameters have been studied in this work such as type of catalysts, reaction time, and CO₂ flowrate. The performance of all the catalysts in CO₂ conversion into CO were summarized in Table 1. X3 catalyst was successfully produced highest CO yield up to 65.5% compare with other series of catalyst. Catalyst X3 and D series were chosen for further reaction parameters study. There are no significant difference in CO yield between CaO and the mixture of CaO/MgO in dolomite. However, 40% Dol-AC showed a little increased in CO yield compared with 30% Dol-AC.

TABLE 1
Catalysts performance in CO₂ conversion into CO

| Catalysts | CO Yield (%) |
|---|---|
| X3 (30% CaO-AC) | 65.5 |
| X3 (30% CaO-AC)- physical mix | 53.0 |
| D3 (30% Dolomite-AC) | 62.2 |
| D4 (40% Dolomite-AC) | 63.7 |
| D5 (50% Dolomite-AC) | 57.2 |
| L3 (La₂O₃-AC) | 52.0 |
| F3 (Fe₂O₃-AC) | 58.0 |
| M3 (MgO-AC) | 33.0 |
| Activated carbon (AC)-without catalyst | 4.0 |

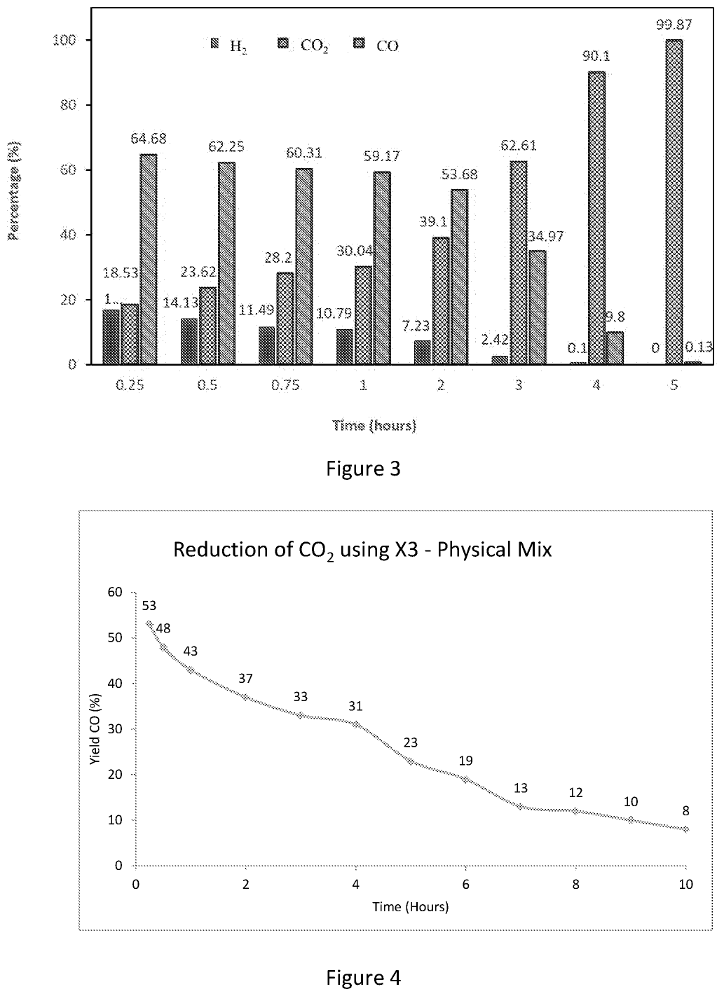

From FIG. 3, it shows performance of X3 catalyst in CO₂ conversion reaction into CO. There is certain amount of H₂ gas was also quantify which is decrease significantly by time at 850° C. Reaction was also remain until 3 hours to achieve 50% in CO yield at 100 mL of CO₂ flowrate. In FIG. 4, it shows reaction performance over physically mix X3 catalyst using simple mixing method. It was clearly shown that physically mix X3 catalyst give a significantly lower CO yield compared to the other catalyst which synthesis using impregnation method. It was showed CO yield reduced by 1 fold after 4 hours of the reaction. Chemical interaction creates between carbon support material and active metal oxide contribute strong CO₂ adsorption on the catalyst surface towards high CO yield at same reaction time. X3 catalyst with impregnation method give highest CO yield up to 65.5% at early reaction time and hold high performance stability for up to 10 hours or more.

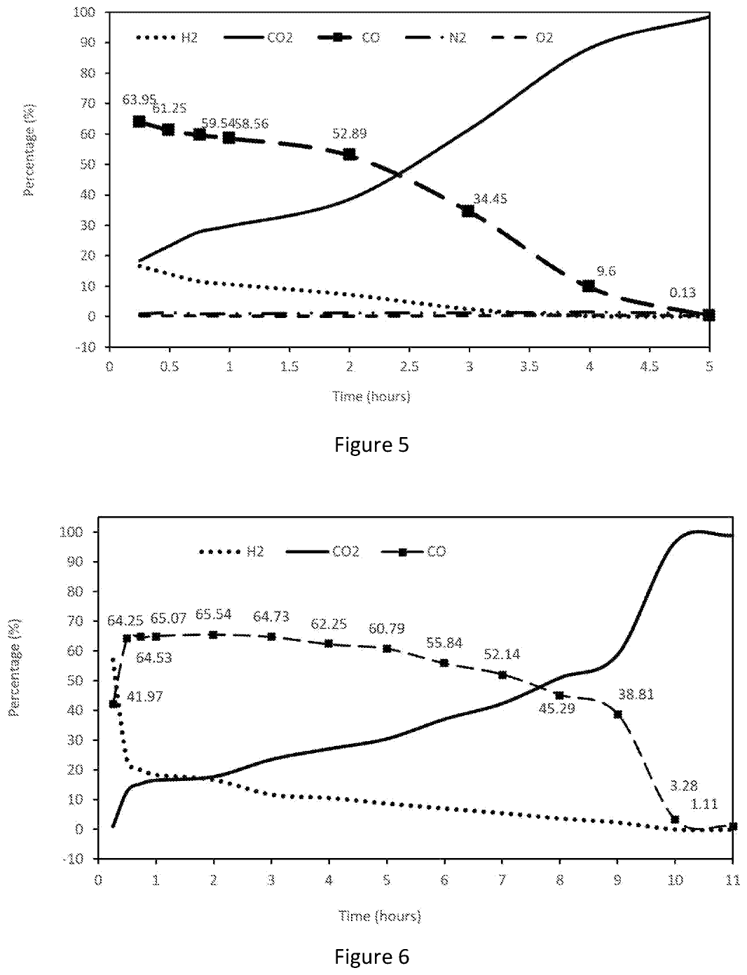

The other main parameter is CO₂ flowrate as a raw material. In this work, we study two different CO₂ flowrate at 50 and 100 mL/min (refer FIG. 5 and FIG. 6). Flowrate of CO₂ contribute to the different reactant residence time and subsequently effect reaction performance. At CO₂ flowrate of 100 mL/min, highest CO yield of 64% was successfully obtained at 10 g of X3 catalyst weight and reaction temperature of 850°C. CO yield was reduced by half after only 3 hours of reaction. However, at same condition and catalyst type, different CO₂ flowrate of 50 mL/min showed a significantly stable in CO yield after 9 hours of reaction. It may be due to low residence time which can facilitate better interaction between reactant and the catalyst and subsequently enhanced CO yield and CO₂ conversion. No oxygen content has been analyzed from the products stream.

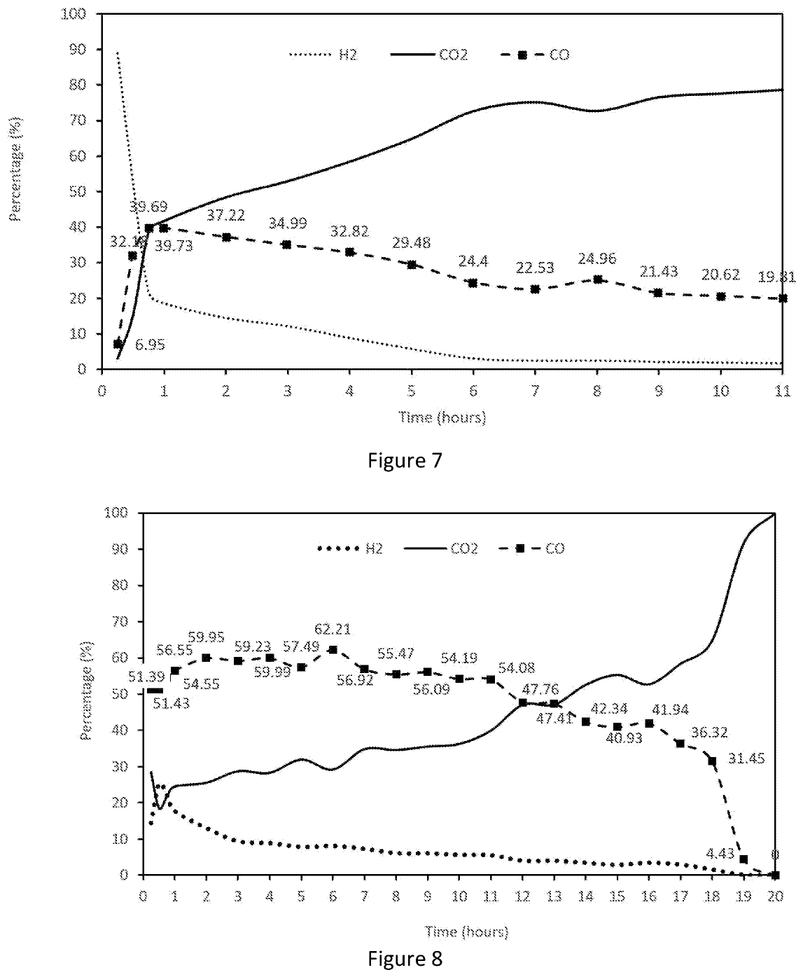

Reaction temperature plays a significant role where CO yield has been increased by reaction temperature increase. At 750° C., highest CO yield was recorded of 39%. It was increased up to 64% after reaction temperature increased up to 850° C. (refer FIG. 6 and FIG. 7). CO yield still can obtain even at lower temperature of 700° C. as shown in Table 2.

TABLE 2
Effect of reaction temperature over CO yield using X3 catalyst

| Reaction Temperature (° C.) | CO yield (%) |
|---|---|
| 850 | 65.5 |
| 800 | 51.3 |
| 750 | 39.0 |
| 700 | 16.1 |

### EXAMPLE 2

### Performance of Dolomite (D) Based Catalyst

XRD pattern showed the change of catalyst phase before and after introducing to CO₂ during the reaction. D3, D4 and D5 was consists of the mixture of CaO and MgO with different percentage over activated carbon support of 30%, 40% and 50%, respectively. After the reaction was completed, all the D4 and D5 catalyst changes into other crystalline phase called CaCO₃ and some of the MgO remains in the system. CaO in CO₂-rich condition was highly active and strongly attracted towards CO₂ and chemically bind to form CaCO₃ at temperature lower than 850°C. However, MgO phase was less active to CO₂ with lower intermolecular attraction at low temperature. Different content of CaO in D series catalyst, D3, D4 and D5 show a dramatically change of CO yield of 62.2%, 63.7% and 57%, respectively (Refer FIG. 8-10). It was noted that no significant improvement has been showed by increasing of CaO/MgO content over activated carbon support from 30% to 40%.

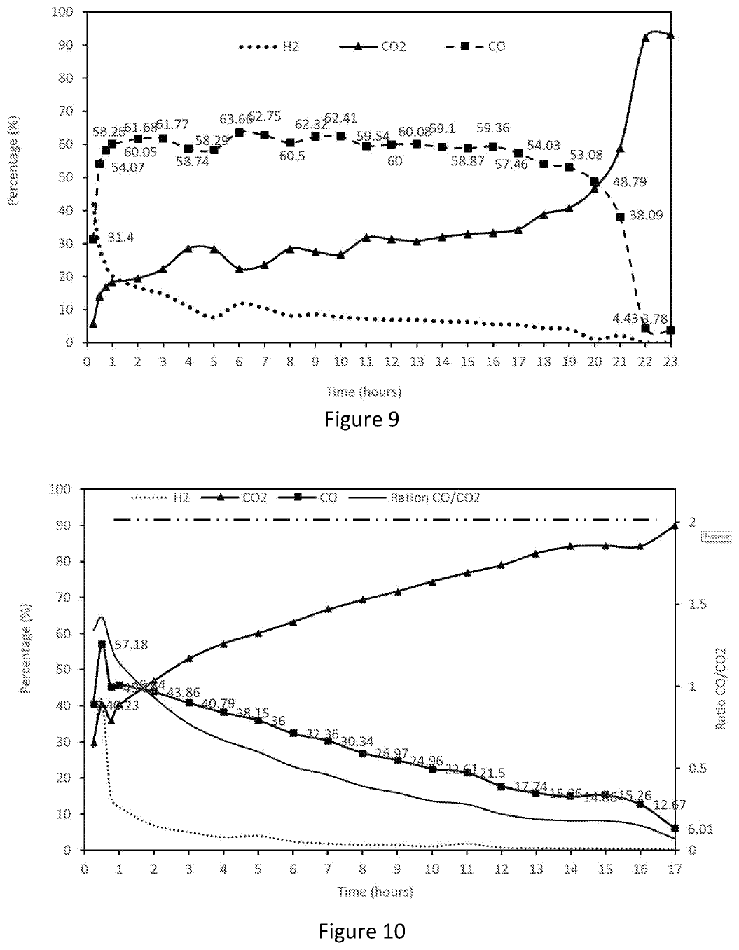

From the results, it showed a much higher in performance compared with CaO or dolomite that was physically mixed with carbon. The strong-medium interaction between D3 or X3 with the activated carbon reactant was effecting the CO yield significantly and subsequently control the stability of the catalyst at optimum carbon and CO₂ conversion into 2 moles of CO. In FIG. 9, it was showed that D4 catalyst has good stability of CO yield which was can remain 38% even after 21 hours of reaction. While, D3 catalyst can obtain same CO yield at 17 hours of reaction. It was also better than X3 catalyst in terms of stability and CO yield which X3 can remain 38.8% after only 9 hours as shown in FIG. 6.

1. An impregnated catalyst composition for production of carbon monoxide comprising:
30 wt %-50% wt metal oxide;
50-70% wt support material.

2. The impregnated catalyst according to claim 1, wherein the metal oxide is selected from calcium oxide, magnesium oxide and combination thereof, ferum oxide and lanthanum oxide.

3. The impregnated catalyst according to claim 2, wherein the source of the metal oxide is selected from calcined dolomite, calcined carbonate, calcined nitrate, and calcined hydroxide.

4. The impregnated catalyst according to claim 1, wherein the support material is selected from activated carbon.

5. The impregnated catalyst according to claim 1, wherein the impregnated catalyst yields carbon monoxide ranging from 33.0%-65.5%.

6. The impregnated catalyst according to claim 1, wherein the impregnated catalyst has high performance stability ranging from 4 hours to 20 hours.

7. A method of preparation of an impregnated catalyst for carbon monoxide production (10) comprising steps of:
providing a precursor and support material (11);
adding the precursor into water to form a solution and adding the solution with a corresponding metal cation into the support material to form a mixture (12);
stirring the mixture to form an impregnated catalyst (13); and
drying and calcining the impregnated catalyst (14).

8. The method of preparation of an impregnated catalyst for carbon monoxide production according to claim 7, wherein the precursor in step (11) is selected from hydroxide or nitrate salt.

9. The method of preparation of an impregnated catalyst for carbon monoxide production according to claim 7, wherein the support material in step (11) is selected from activated carbon.

10. The method of preparation of an impregnated catalyst for carbon monoxide production according to claim 7 wherein the stirring step in step (13) is conducted for 3-5 hours at 40° C.-80° C.

11. The method of preparation of an impregnated catalyst for carbon monoxide production according to claim 7, wherein the drying is conducted at a temperature of 110° C.-150° C. for overnight.

12. The method of preparation of an impregnated catalyst for carbon monoxide production according to claim 7, wherein the calcining step is conducted at a temperature of 400° C.-850° C.

13. The method of preparation of an impregnated catalyst for carbon monoxide production according to claim 7, wherein the impregnated catalyst is prepared with a ratio of 30 wt %-50 wt % precursor, 50-70 wt % support material.

14. The method of preparation of an impregnated catalyst for carbon monoxide production according to claim 7, wherein the produced impregnated catalyst yields carbon monoxide ranging from 33.0%-65.5%.

15. The method of preparation of an impregnated catalyst for carbon monoxide production according to claim 7 wherein the produced impregnated catalyst has high performance stability ranging from 4 hours to 20 hours.

16. A method for carbon monoxide production (20) comprising the steps of;
an impregnated catalyst according to claim 1 to claim 6 into a reactor (21);
heating the impregnated catalyst with flowing nitrogen gas at a selected flow rate until reach selected temperature (22);
reacting the heated impregnated catalyst with flowing carbon dioxide gas at a selected flow rate to produce carbon monoxide (23); and
regain the impregnated catalyst for reuse; wherein the steps occur simultaneously within the reactor, thereby the selectively carbon monoxide is collected at a temperature range of 700° C.-850° C. (24).

17. The method of carbon monoxide production according to claim 16, wherein the reactor in step (21) is selected from a fluidized bed reactor or fixed bed reactor.

18. The method of carbon monoxide production according to claim 16, wherein the selected flow rate of carbon dioxide gas is ranging from 50-100 mL/min.

19. The method of carbon monoxide production according to claim 16, wherein the selected flow rate of nitrogen gas is ranging from 50-100 mL/min.

20. Use of the catalyst according to claim 2 for carbon monoxide production wherein reaction temperature is reduced by 1 fold.

21. Use of the catalyst according to claim 2 for carbon monoxide production wherein the reaction temperature ranges from 700° C.-850° C.
